(19) United States
(12) Patent Application Publication
(10) Pub. No.: US 2019/0232187 A1
(43) Pub. Date: Aug. 1, 2019

(54) SAND MOLDING KIT

(71) Applicant: Susan Schneider, Prosser, WA (US)

(72) Inventor: Susan Schneider, Prosser, WA (US)

(21) Appl. No.: 15/883,377

(22) Filed: Jan. 30, 2018

(51) Int. Cl. A63H 33/32; A63H 33/00

(52) U.S. Cl. CPC A63H 33/32; B44C 3/046; A63H 33/001

(57) ABSTRACT

A sand molding kit for molding sand to the shape of a human body includes a plurality of molds. Each of the molds includes an inner surface, an outer surface and a perimeter edge. The inner surface is concavely shaped and the outer surface is convexly shaped. Each of the molds is fillable with sand such that the sand retains a shape of a corresponding one of the molds. A plurality of adornments is included wherein each of the adornments is positionable on sand molded with the plurality of molds.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to sand molding devices and more particularly pertains to a new sand molding device for molding sand to the shape of a human body.

### BRIEF SUMMARY OF THE INVENTION

An embodiment of the disclosure meets the needs presented above by generally comprising a plurality of molds. Each of the molds includes an inner surface, an outer surface and a perimeter edge. The inner surface is concavely shaped and the outer surface is convexly shaped. Each of the molds is fillable with sand such that the sand retains a shape of a corresponding one of the molds. A plurality of adornments is included wherein each of the adornments is positionable on sand molded with the plurality of molds.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top view of a sand molding kit according to an embodiment of the disclosure.

FIG. 2 is a top side view of an embodiment of the disclosure.

FIG. 3 is a bottom view of an embodiment of the disclosure.

FIG. 4 is a top view of an embodiment of the disclosure.

FIG. 5 is a cross-sectional view of an embodiment of the disclosure taken along line 5-5 of FIG. 4.

FIG. 6 is a front view of an embodiment of the disclosure.

FIG. 7 is a front view of an embodiment of the disclosure.

FIG. 8 is a front view of an embodiment of the disclosure.

FIG. 9 is a front view of an embodiment of the disclosure.

FIG. 10 is a front view of an embodiment of the disclosure.

FIG. 11 is a front view of an embodiment of the disclosure.

FIG. 12 is a front view of an embodiment of the disclosure.

FIG. 13 is a front view of an embodiment of the disclosure.

FIG. 14 is a top view of an embodiment of the disclosure.

### DETAILED DESCRIPTION OF THE INVENTION

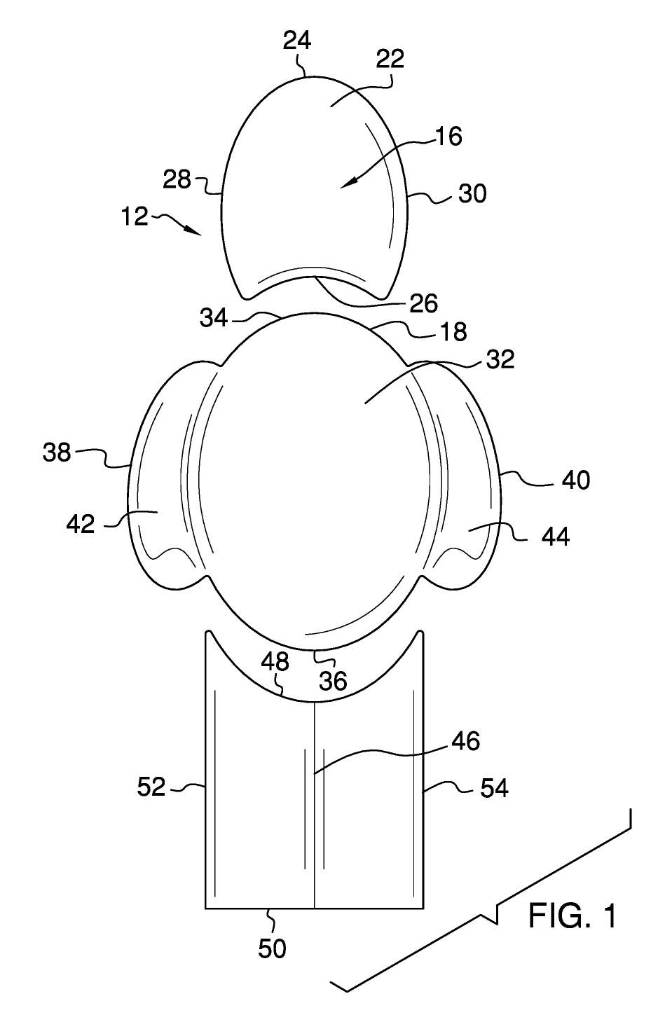

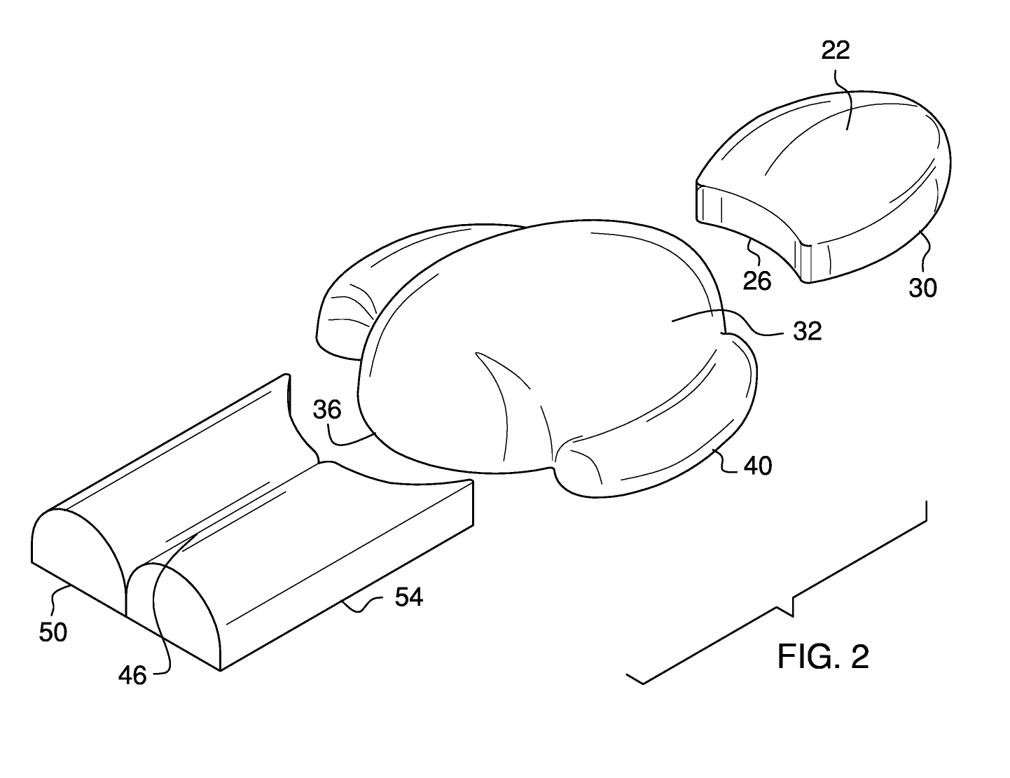

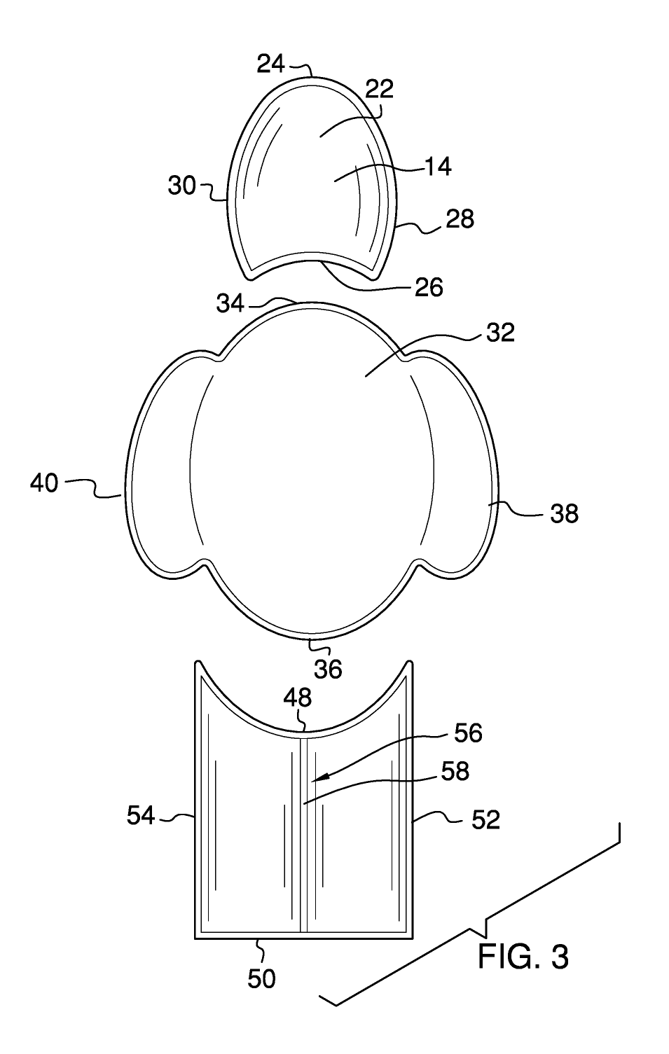

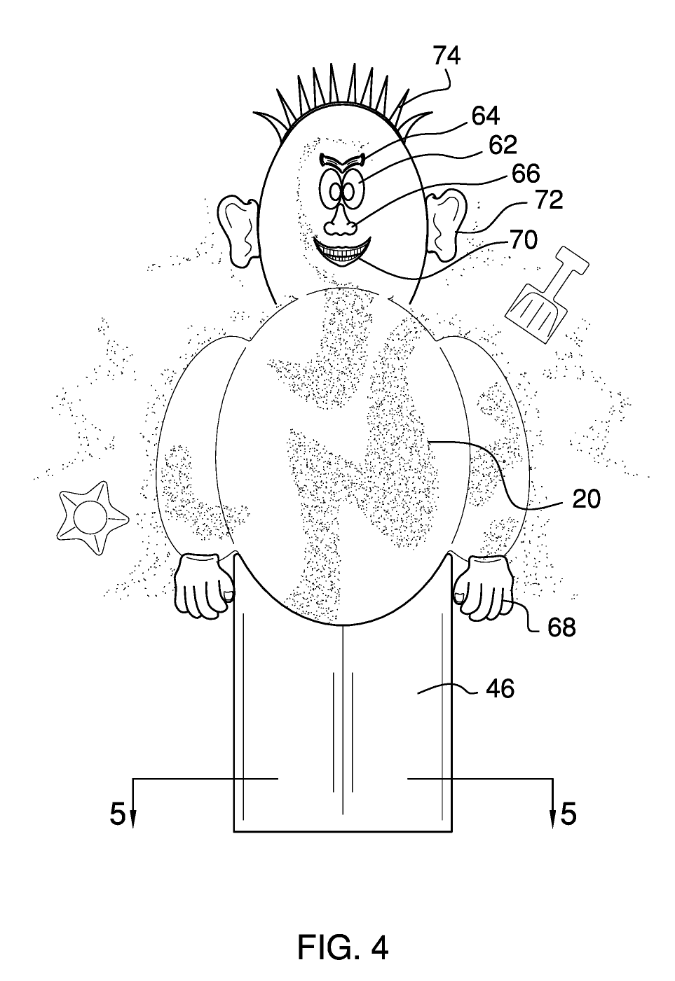

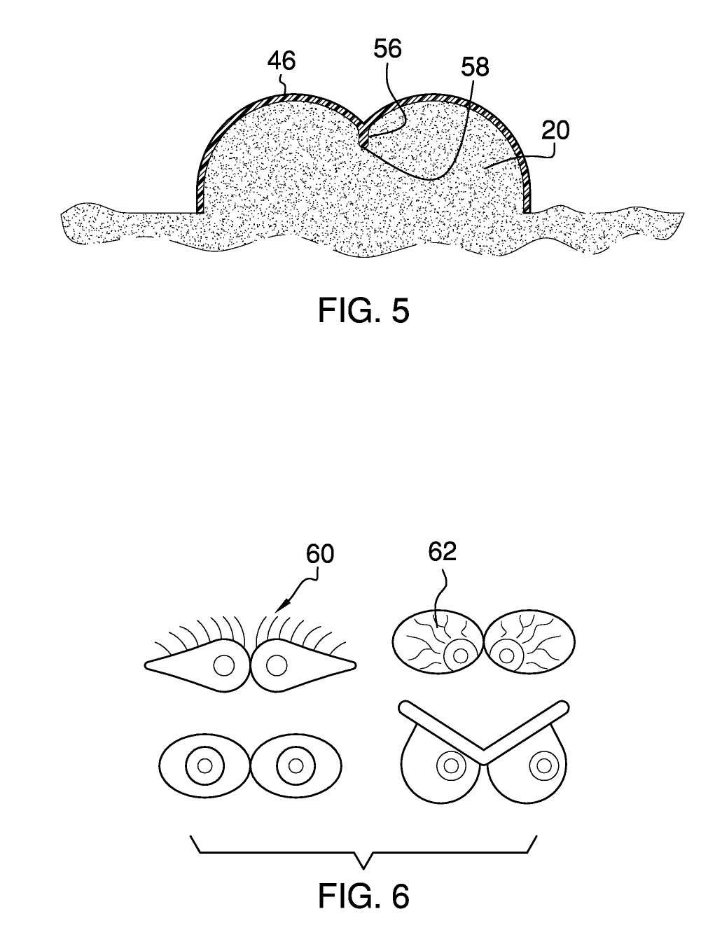

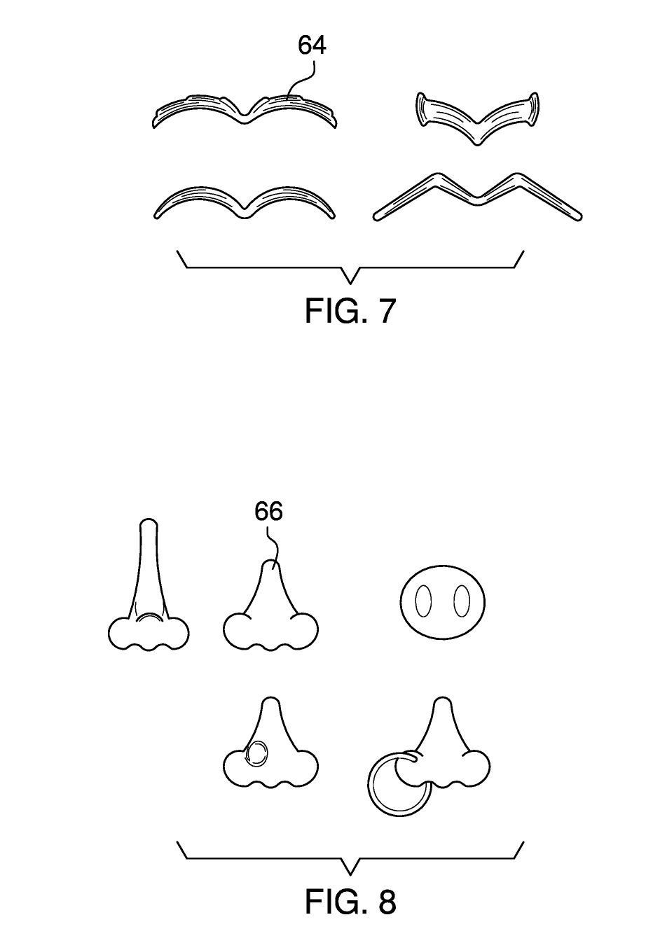

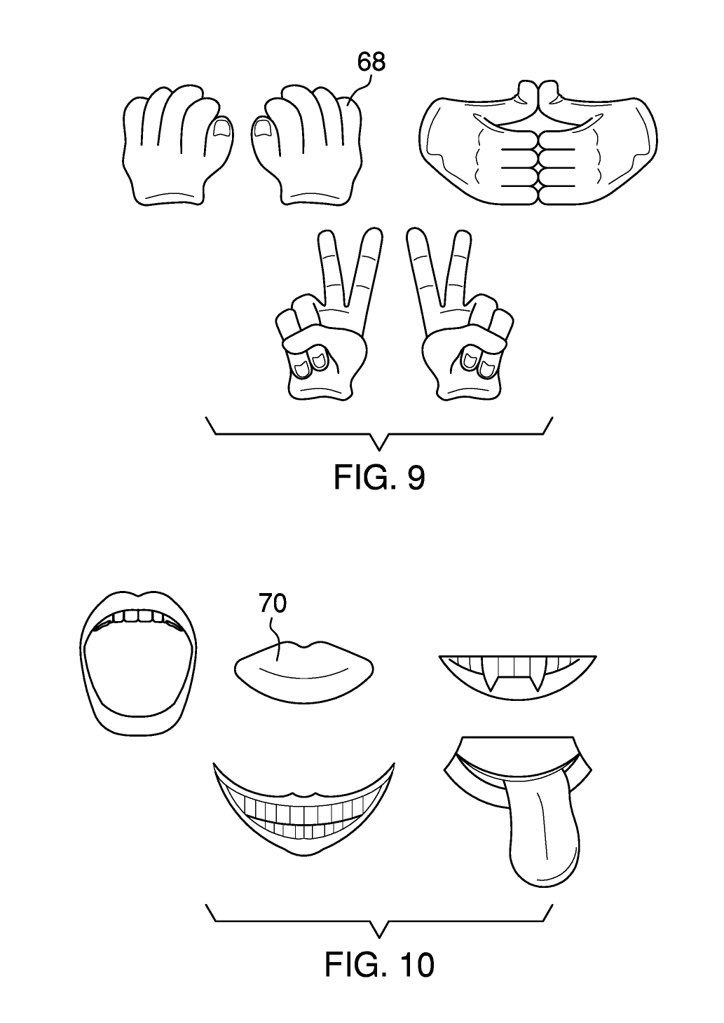

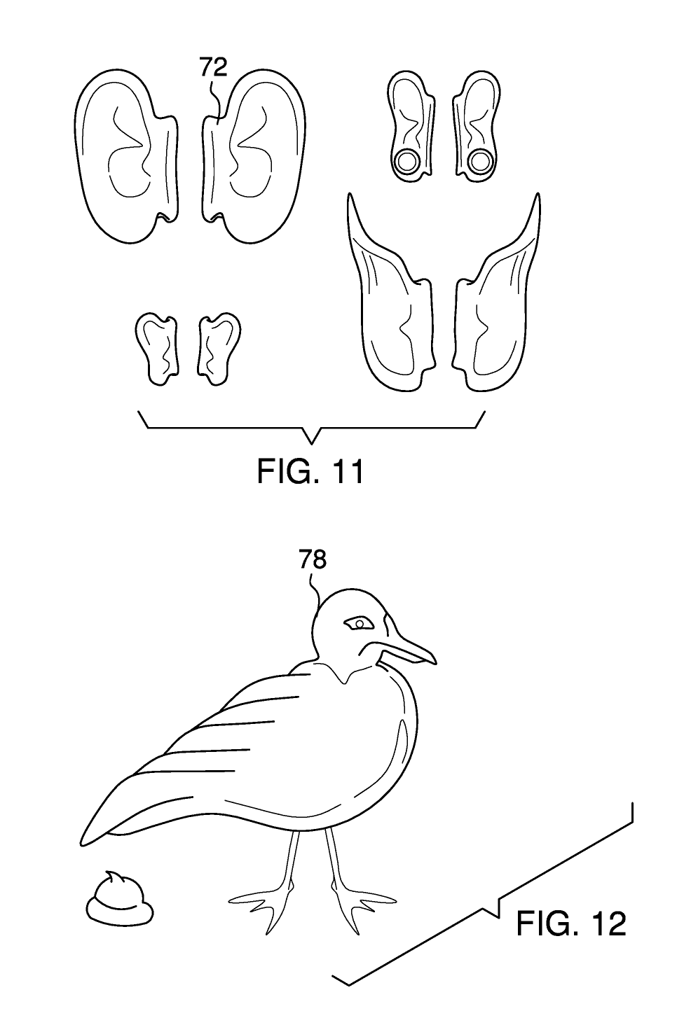

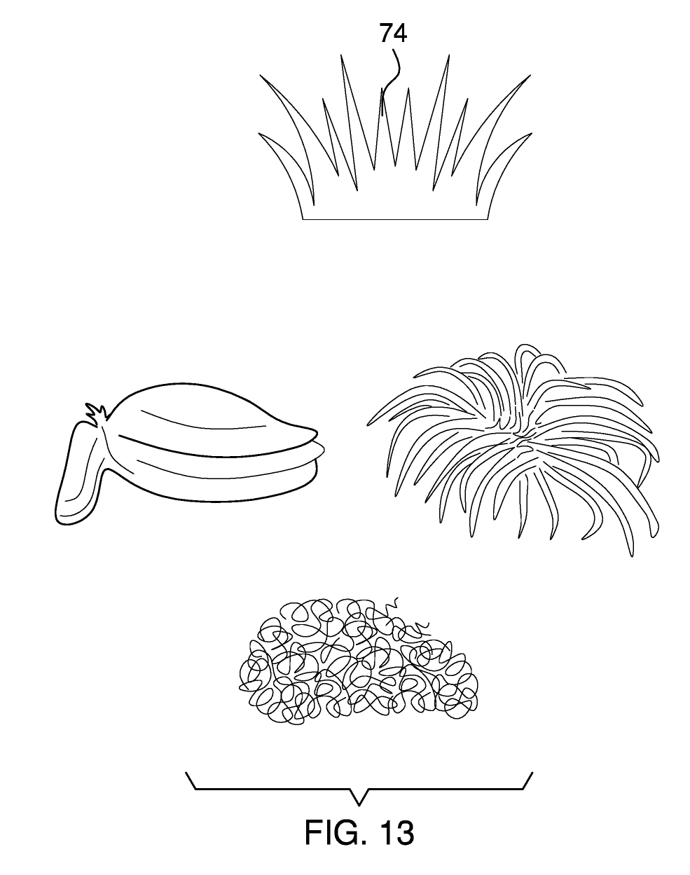

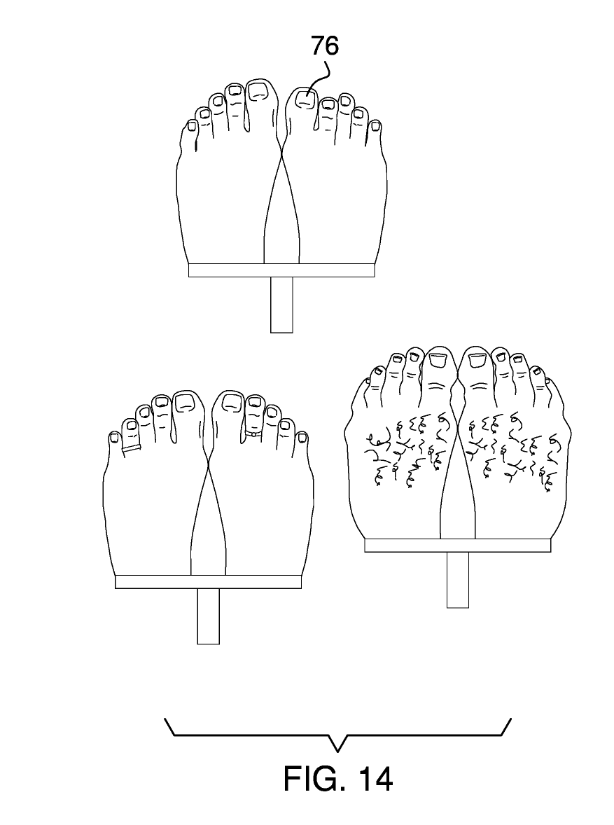

With reference now to the drawings, and in particular to FIGS. 1 through 14 thereof, a new sand molding device embodying the principles and concepts of an embodiment of the disclosure and generally designated by the reference numeral 10 will be described.

As best illustrated in FIGS. 1 through 14, the sand molding kit 10 generally comprises a plurality of molds 12 wherein each of the molds 12 includes an inner surface 14, an outer surface 16 and a perimeter edge 18. The inner surface 14 is concavely shaped and the outer surface 16 is convexly shaped. Each of the molds 12 is fillable with sand 20 such that the sand 20 retains a shape of a corresponding one of the molds 12.

One of the molds 12 defines a head 22 wherein the perimeter edge 18 of the head includes a crown edge 24, a chin edge 26, a right ear edge 28 and a left ear edge 30. The chin edge 26 is concavely arcuate such that the chin edge 26 extends toward the crown edge 24. The crown edge 24 is convexly arcuate such that the crown edge 24 extends outwardly away from the chin edge 26. The right ear edge 28 and the left ear edge 30 are convexly arcuate and extend outwardly away from each other 28, 30. The head 22 has a depth from a plane that extends across the perimeter edge 18 to the inner surface 14 that is between 3 inches and 5 inches.

One of the molds 12 defines a torso 32 wherein the perimeter edge 18 of the torso 32 includes a neck edge 34, a stomach edge 36, a right arm edge 38 and a left arm edge 40. The neck edge 34 and the stomach edge 36 are convexly arcuate and extend outwardly away from each other 34, 36. The neck edge 34 is abuttable against the chin edge 26 of the head 22. The torso 32 has a depth from a plane that extends across the perimeter edge 18 to the inner surface 14 that is between 7 inches and 9 inches. The right arm edge 38 and the left arm edge 40 have an arch shape and extend outwardly away from each other 38, 40. The right arm edge 38 defines a right arm 42 and the left arm edge 40 defines a left arm 44. The right arm 42 and the left arm 44 have depths from a plane that extends across the perimeter edge 18 to the inner surface 14 that is between 5 inches and 7 inches.

One of the molds 12 defines a pelvis and a pair of legs 46 wherein the perimeter edge 18 of the pelvis and pair of legs 46 includes a pelvis edge 48, a foot edge 50, a first lateral edge 52 and a second lateral edge 54. The pelvis edge 48 is concavely arcuate and extends toward the foot edge 50 such that the pelvis edge 48 is abuttable against the stomach edge 36 of the torso 32 such that the pelvis edge 48 is coextensive with the stomach edge 36. The first lateral edge 52 and the second lateral edge 554 are perpendicular to the foot edge 50. The pelvis and pair of legs 46 has a dividing wall 56 that is attached to the inner surface 14 and extends outwardly therefrom. The dividing wall 56 extends from the pelvis edge 48 to the foot edge 50 parallel to the first lateral edge 52 and the second lateral edge 54. The dividing wall 56 has a dividing edge 58 that is coextensive with the pelvis edge 48 and the foot edge 50. The pelvis and the pair of legs 56 has a depth from a plane that extends across the perimeter edge 18 to the inner surface 14 that is between 3 inches and 5 inches.

A plurality of adornments 60 is included wherein each of the adornments 60 is positionable on sand molded 20 with the plurality of molds 12. The adornments 60 may take the shape of an eye 62, an eye brow 64, a nose 66, a hand 68, a mouth 70, an ear 72, a hairpiece 74, a foot 76 or an animal 78 but do not necessarily need to do so. Furthermore, the adornments 60 may have an insert end 80 that is to be extended into the molded sand to secure the adornment 60 thereto.

In use, each of the molds 12 is filled with sand 20. The sand 20 is released outwardly from the corresponding mold 12 in the molded shape. Selected ones of the adornments 60 are positioned on the molded sand 20 to decorate the molded sand 20.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A sand sculpting and decorating kit comprising:
a plurality of molds, each of said molds including an inner surface, an outer surface and a perimeter edge, said inner surface being concavely shaped, said outer surface being convexly shaped, each of said molds being fillable with sand such that the sand retains a shape of a corresponding one of said molds; and
a plurality of adornments, each of said adornments being positionable on sand molded with said plurality of molds, each of said adornments having an insert end extending outwardly wherein said insert end of each of said adornments is configured for being inserted into the sand wherein said adornment is secured thereto.

2. The sand sculpting and decorating kit according to claim 1, wherein one of said molds defines a head, said perimeter edge of said head including a crown edge, a chin edge, a right ear edge and a left ear edge.

3. The sand sculpting and decorating kit according to claim 2, wherein said chin edge is concavely arcuate such that said chin edge extends toward said crown edge, said crown edge being convexly arcuate such that said crown edge extends outwardly away from said chin edge.

4. The sand sculpting and decorating kit according to claim 3 wherein, said right ear edge and said left ear edge being convexly arcuate and extending outwardly away from each other.

5. The sand sculpting and decorating kit according to claim 4, said head has a depth from a plane extending across said perimeter edge to said inner surface being between 3 inches and 5 inches.

6. The sand sculpting and decorating kit according to claim 2, wherein one of said molds defines a torso, said perimeter edge of said torso including a neck edge, a stomach edge, a right arm edge and a left arm edge.

7. The sand sculpting and decorating kit according to claim 6, wherein said neck edge and said stomach edge are convexly arcuate and extending outwardly away from each other, said neck edge being abuttable against said chin edge of said head.

8. The sand sculpting and decorating kit according to claim 7, wherein said torso has a depth from a plane extending across said perimeter edge to said inner surface being between 7 inches and 9 inches.

9. The sand sculpting and decorating kit according to claim 8, wherein said right arm edge and said left arm edge have an arch shape and extend outwardly away from each other.

10. The sand sculpting and decorating kit according to claim 9, wherein said right arm edge defines a right arm and said left arm edge defines a left arm, said right arm and said left arm having a depth from a plane extending across said perimeter edge to said inner surface being between 5 inches and 7 inches.

11. The sand sculpting and decorating kit according to claim 6, wherein one of said molds defines a pelvis and a pair of legs, said perimeter edge of said pelvis and pair of legs including a pelvis edge, a foot edge, a first lateral edge and a second lateral edge.

12. The sand sculpting and decorating kit according to claim 11, wherein said pelvis edge is concavely arcuate and extends toward said foot edge such that said pelvis edge is abuttable against said stomach edge of said torso such that said pelvis edge is coextensive with said stomach edge.

13. The sand sculpting and decorating kit according to claim 12, wherein said first lateral edge and said second lateral edge are perpendicular to said foot edge.

14. The sand sculpting and decorating kit according to claim 13, wherein said pelvis and pair of legs has a dividing wall being attached to said inner surface and extending outwardly therefrom, said dividing wall extending from said pelvis edge to said foot edge parallel to said first lateral edge and said second lateral edge.

15. The sand sculpting and decorating kit according to claim 14, wherein said dividing wall has a dividing edge being coextensive with said pelvis edge and said foot edge.

16. The sand sculpting and decorating kit according to claim 15, wherein said pelvis and said pair of legs has a depth from a plane extending across said perimeter edge to said inner surface being between 3 inches and 5 inches.

17. A sand sculpting and decorating kit comprising:
a plurality of molds, each of said molds including an inner surface, an outer surface and a perimeter edge, said inner surface being concavely shaped, said outer surface being convexly shaped, each of said molds being fillable with sand such that the sand retains a shape of a corresponding one of said molds;
one of said molds defining a head, said perimeter edge of said head including a crown edge, a chin edge, a right ear edge and a left ear edge, said chin edge being concavely arcuate such that said chin edge extends toward said crown edge, said crown edge being convexly arcuate such that said crown edge extends outwardly away from said chin edge, said right ear edge and said left ear edge being convexly arcuate and extending outwardly away from each other, said head having a depth from a plane extending across said perimeter edge to said inner surface being between 3 inches and 5 inches;
one of said molds defining a torso, said perimeter edge of said torso including a neck edge, a stomach edge, a right arm edge and a left arm edge said neck edge and said stomach edge being convexly arcuate and extending outwardly away from each other, said neck edge being abuttable against said chin edge of said head, said torso having a depth from a plane extending across said perimeter edge to said inner surface being between 7 inches and 9 inches, said right arm edge and said left arm edge having a arch shape and extending outwardly away from each other, said right arm edge defining a right arm and said left arm edge defining a left arm, said right arm and said left arm having a depth from a plane extending across said perimeter edge to said inner surface being between 5 inches and 7 inches;
one of said molds defining a pelvis and a pair of legs, said perimeter edge of said pelvis and pair of legs including a pelvis edge, a foot edge, a first lateral edge and a second lateral edge said pelvis edge being concavely arcuate and extending toward said foot edge wherein said pelvis edge is abuttable against said stomach edge of said torso such that said pelvis edge is coextensive with said stomach edge, said first lateral edge and said second lateral edge being perpendicular to said foot edge, said pelvis and pair of legs having a dividing wall being attached to said inner surface and extending outwardly therefrom, said dividing wall extending from said pelvis edge to said foot edge parallel to said first lateral edge and said second lateral edge, said dividing wall having a dividing edge being coextensive with said pelvis edge and said foot edge, said pelvis and said pair of legs having a depth from a plane extending across said perimeter edge to said inner surface being between 3 inches and 5 inches; and
a plurality of adornments, each of said adornments being positionable on sand molded with said plurality of molds, each of said adornments having an insert end extending outwardly wherein said insert end of each of said adornments is configured for being inserted into the sand wherein said adornment is secured thereto.
